(19) United States
(12) Patent Application Publication
(10) Pub. No.: US 2025/0309409 A1
(43) Pub. Date: Oct. 2, 2025

(54) BATTERY DEVICE

(71) Applicant: Rheinisch-Westfälische Technische Hochschule (RWTH) Aachen, Aachen (DE)

(72) Inventors: Maximilian Schirp, Aachen (DE); Stefano PIACQUADIO, Aachen (DE); Jannik BÜHRING, Aachen (DE); Tobias MEINERT, Aachen (DE); Tom RATHMES, Aachen (DE); Kai-Uwe SCHRÖDER, Aachen (DE)

(21) Appl. No.: 18/864,331

(22) PCT Filed: May 9, 2023
(86) PCT No.: PCT/EP2023/062240

§ 371 Date: Nov. 8, 2024

(30) Foreign Application Priority Data
May 11, 2022 (DE) 10 2022 111 769.3

(51) Int. Cl. H01M 10/659; H01M 10/613; H01M 10/625; H01M 10/627; H01M 10/643; H01M 10/6568; H01M 50/213; H01M 50/249; H01M 50/251; H01M 50/271; H01M 50/291

(52) U.S. Cl. CPC H01M 10/659; H01M 10/613; H01M 10/625; H01M 10/627; H01M 10/643; H01M 10/6568; H01M 50/213; H01M 50/249; H01M 50/251; H01M 50/271; H01M 50/291; H01M 2220/10; H01M 2220/20

(57) ABSTRACT

A battery device has a housing, a core structure arranged in the housing, a first interior space in the housing configured for a cooling fluid to flow through, a second interior space in the housing, a phase change material and at least one battery cell. The core structure separates the first interior space from the second interior space. The core structure has a wall which is configured substantially in the form of a triple periodic minimum surface. The phase change material is arranged in the second interior space. The at least one battery cell is arranged in the first interior space or the second interior space.

### CROSS-REFERENCE TO RELATED APPLICATIONS

This application is a U.S. National Phase of International Patent Application No. PCT/EP2023/062240, entitled “BATTERY DEVICE”, filed on May 9, 2023, which claims priority to German Patent Application No. 1020222111769.3, filed May 11, 2022, the entire contents of each which are incorporated herein by reference in their entirety.

### TECHNICAL FIELD

The present invention relates to a battery device.

### BACKGROUND

Batteries have to provide large currents for modern applications, for example as energy stores in electric cars or drones. However, this can result in a very rapid heating of respective battery cells. Batteries have an optimum operating temperature range which is, for example, close to room temperature. In this temperature range, the battery can be particularly powerful. By contrast, at excessively high or excessively low temperatures, degradation of the battery accelerates. If a maximum temperature is exceeded, even self-ignition of the battery can occur, which is also referred to as thermal runaway. Accordingly, the temperature is usually controlled by a temperature control system.

Temperature control systems of batteries can be separated according to two operating principles. An active cooling can set the operating temperature of the battery, for example by an adjustable throughflow of cooling fluid. However, the active cooling requires energy, as a result of which a system efficiency can decrease. In addition, cooling or heating of the battery by the surroundings cannot be prevented during downtime. In the case of a passive cooling, there is no energy consumption, but the operating temperature cannot always be kept in a desired range. Overall, a battery cooling can require additional installation space and can be very heavy. Depending on the climate zone, a heating of the battery can also be intended. The heating can also take place actively or passively.

In US 2013/00844871 A1, a battery with phase change material is described.

U.S. Pat. No. 7,866,377 B2 describes a use of minimal surfaces in heat exchangers.

### DESCRIPTION OF THE INVENTION

A first aspect of the invention relates to a battery device. The battery device can be configured, for example, for a motor vehicle, such as an electric car. The battery device can be configured as a battery store in a building, in particular used in a wallbox for charging electric cars. The battery device can also be used, for example, in a drone or an electric motorcycle. The battery device can be configured as an energy store for electrical energy. The battery device can be configured for multiple charging and discharging.

The battery device can have a housing. The housing can delimit a housing interior space. The housing can be made, for example, from plastic or metal. The housing can have a plurality of wall elements or can also be configured as a unitarian one-piece element. The housing can protect respective other elements of the battery device from environmental influences and, for example, enable a fastening, in particular in a vehicle and/or at a building. The battery device can have electrical contacts.

The battery device has a core structure arranged in the housing. The core structure can be configured to divide the housing interior space into at least two subspaces. The core structure can provide an additional protective function to protect battery cells from mechanical influences. The core structure can form a load-bearing structure. The core structure may, for example, be permanently connected to the housing or maybe configured as a unitarian one-piece element. As a result of the connection to the housing, the core structure can support the housing and thus additionally reinforce it.

The battery device has a first interior space in the housing. The first interior space is configured for a cooling fluid to flow through. For this purpose, the first interior space can have one or more access openings, in particular configured as through-openings in the housing. As a result, a cooling fluid can flow through the first interior space. The battery device may have, for example, a pump device for conveying the cooling fluid through the first interior space, which pump device may be arranged inside or outside the housing. In addition, a heat exchanger can be provided, in particular outside the housing, for example in order to cool the cooling fluid. Alternatively or additionally, the battery device may have a heater, for example in order to heat the cooling fluid. The battery device can thus have an active temperature control, in particular at least configured for cooling, in order to reliably keep an operating temperature in a desired range. Alternatively or additionally, the battery device can also be heated by means of the cooling fluid, depending on the ambient temperature. The cooling fluid may be, for example, air, water or a water-glycol mixture.

The battery device has a second interior space in the housing. The second interior space may, for example, be fluidically separated from the first interior space. The battery device has a phase change material. The phase change material is arranged in the second interior space. As a result, mixing with the cooling fluid can be avoided. A phase change material may have a high melting enthalpy. The phase change material may, for example, be a paraffin wax. A further example of a phase change material is an aluminum-silicon alloy. Further examples of phase change materials are present, for example, in the field of salt hydrates, alcohols, fatty acids and salts. In addition, a fire-retardant additive may be added to the phase change material. The phase change material may be selected such that it changes between two phases, in particular a liquid and a solid state, in or close to the desired operating temperature range of the battery device. The phase change material may have a high effective thermal mass which greatly increases a thermal inertia of the battery device. As a result, an undesirably rapid and/or high temperature rise or also temperature drop can be prevented or at least slowed down. As a result, it is easier to keep the desired operating temperature of the battery device. In addition, the active cooling can be dimensioned to be smaller, since it no longer has to absorb respective thermal reactions of the battery alone. The phase change material can dampen load peaks for unburdening the active cooling and/or heater. In addition, even during downtime, that is to say, for example, when the battery device is switched off, the phase change material can keep a temperature of the battery device better or with a lower mass and volume than would be possible without a phase change material. As a result, a service life of the battery device can be high. As a result of the phase change material, the battery device can be particularly light, since respective active cooling components can be dimensioned to be smaller. In addition, the system efficiency with such a battery device can be greater, since less energy may be necessary for the active cooling. Since the battery device can be better kept in its optimum operating temperature range, a service life of the battery device may also be particularly high.

The battery device has at least one battery cell. The battery cell can be configured, for example, as a galvanic cell. The battery cell can be an electrochemical energy store and an energy converter. The battery cell may be, for example, a cylindrical battery cell, a prismatic battery cell or a pouch cell. The battery device may have a plurality of battery cells which can be arranged in a specific packing in the housing. For example, the battery cells may be arranged uniformly at specific distances from one another in a plane. All the battery cells of the battery device can be configured identically. However, the battery device may also have two or more different battery cell types. In the following, it will be referred to the battery cell for simplification, wherein this may then always also relate to a plurality of or all of the battery cells, if applicable.

The core structure separates the first interior space from the second interior space. The core structure can form a separating wall in the housing interior space. The separation can be fluid-tight, in particular for the phase change material and the cooling fluid. The core structure has a wall which is configured substantially in the form of a triple periodic minimum surface. The separating wall can partially or completely delimit at least one of the two interior spaces. The separating wall can also at least partially or completely delimit both interior spaces. The triple periodic minimum surface may have a symmetry of a crystal structure. The triple periodic minimum surface may be free of interfaces. Details of the triple periodic minimum surface will be explained even further down below. The triple periodic minimum surface can form a particularly large surface area, so that heat can be transmitted particularly well and uniformly between the two interior spaces. The triple periodic minimum surface may form an associated recess for each battery cell, for example in the second interior space. The wall of the core structure may be formed, for example, from a metallic material or plastic. The triple periodic minimum surface can form two channels in conjunction with the housing. Heat can be transmitted particularly well between the cooling fluid and the phase change material via the triple periodic minimum surface. The combination of active cooling and thermal damping by the phase change material may thus be particularly efficient. The phase change material can also particularly well prevent thermal runaway.

The at least one battery cell is arranged in the first interior space or the second interior space. As a result of the arrangement in the second interior space, an undesirably rapid heating and also cooling of the battery cell can be damped particularly well by the phase change material. Thus, each battery cell can be kept in a desired operating temperature range with a particularly minimal active temperature control. As a result of the arrangement in the first interior space, the operating temperature of the battery cell can be set particularly precisely and reliably. Nevertheless, thermal load peaks can be damped by the phase change material.

In one embodiment of the battery device, it is provided that the first interior space and/or the second interior space is delimited on one side by a cover layer. This cover layer may be formed, for example, by a part of the housing. On an opposite side, the first interior space and/or the second interior space may be delimited by a further cover layer. This further cover layer may also be formed, for example, by a part of the housing. The cover layers may be connected to the core structure. Each cover layer may not be electrically conductive. Each cover layer may be formed, for example, as a plate made of an electrically insulating material. Each cover layer may also be formed, for example, from a composite material and thus be particularly mechanically resistant. The cover layers may regionally abut the core structure and/or form a sandwich structure with the core structure. As a result, the battery device may be configured as a load-bearing structure. As a result, it is possible, for example, to dispense with reinforcements in a vehicle for installation of this battery device. The battery device may thus be configured, for example, as a load-bearing part of a chassis. The cover layers may rest, for example, on opposite sides on the wall configured as a triple periodic minimum surface and thus delimit or completely close the respective recesses for battery cells on an upper side and lower side. The cover layers may be connected to the core structure, for example by a joining method, such as welding, adhesive bonding or soldering. However, the two cover layers may also be connected to one another, for example, for example, by a screw connection and clamp the core structure therebetween. The two cover layers may also be pressed against the core structure by the housing.

In one embodiment of the battery device, it is provided that at least one of the cover layers has at least one through opening for access to a battery contact of the battery cell and/or for the cooling fluid to flow through. Separate through openings may also be provided for the cooling fluid flow and the electrical contacting. The through opening may be aligned with the recess for the battery cell, for example. An associated through opening may be provided for each battery cell. The through openings may be provided only in one or both cover layers. One or more lines, for example power lines and/or fluid lines, may be guided through the through opening. The through opening may otherwise be sealed. As a result, fluid and/or electrical current can be guided into and out of the first interior space and/or second interior space.

In one embodiment of the battery device, it is provided that at least one of the cover layers has a conducting path which is contacted with the battery cell, in particular wherein the conducting path is arranged on an outer side of the cover layer. For example, the conducting path may be connected to the battery cell through the through opening. An associated conducting path may be provided per battery cell. However, the conducting path may, for example, also be electrically connected to one or more battery cells. The conducting path may be fastened to the cover layer. The conducting path may also be formed integrally with the cover layer, for example, by etching in or depositing on the cover layer. As a result of the conducting path, an electrical connection to respective battery cells can be provided in a compact, robust and space-saving manner.

In one embodiment of the battery device, it is provided that the core structure has been manufactured with an additive method. For example, the core structure may be produced with a metallic 3D printing. As a result, the complex wall can be manufactured in a particularly simple manner in the form of a triple periodic minimum surface, in particular in one step and/or as a unitarian one-piece element. For example, large undercuts may thus also be manufactured in a simple manner. Alternatively or additionally, the core structure may have been manufactured with a casting method. For example, two semi-finished products manufactured in a casting process may form the core structure. As a result, particularly massive core structures can be manufactured cost-effectively. Alternatively or additionally, the core structure may have been manufactured with a machining method. For example, two semi-finished products manufactured with a milling method may form the core structure. As a result, a particularly resistant core structure can be provided. Alternatively or additionally, the core structure may be manufactured with a forming method. For example, two semi-finished products manufactured with a deep-drawing process from sheets may form the core structure. As a result, a particularly cost-effective mass production is possible.

In one embodiment of the battery device, it is provided that the core structure is formed from two semi-finished products joined to one another. For example, the core structure may be formed from an upper shell and a lower shell, which form respective recesses for the battery cells therebetween. The manufacture may thus be particularly simple, in particular since undercuts in the semi-finished products may be avoided. In addition, the battery cells may thus be inserted into the recesses in a particularly simple manner. The semi-finished products may be symmetrical to one another. For example, the core structure may also have three or more semi-finished products joined to one another. The semi-finished products may be connected to one another, for example by a joining method, such as welding, adhesive bonding or soldering.

In one embodiment of the battery device, it is provided that the core structure further has a first grid structure which is arranged in the first interior space. The first grid structure may increase a load-bearing capacity of the battery device. For example, the first grid structure may support the core structure on the housing and/or the cover layers and connect them to one another. In addition, the first grid structure may increase a thermal conductivity, in particular by increasing a surface area around which the cooling fluid flows. Preferably, the first grid structure is a coarse grid structure with a large distance between individual grid rods in order to keep a pressure loss low when the cooling fluid flows through the first interior space.

In one embodiment of the battery device, it is provided that the core structure further has a second grid structure which is arranged in the second interior space. The second grid structure may be provided alternatively or additionally to the first grid structure. The second grid structure may increase a load-bearing capacity of the battery device. For example, the second grid structure may support the core structure on the housing and/or the cover layers and connect them to one another. The second grid structure may also increase a mechanical resistance of the core structure itself, for example, in that different wall regions in the recesses for the battery cells are connected to one another via the second grid structure. The second grid structure may, for example, also hold the battery cells, in particular when the phase change material changes into its liquid state. In addition, the second grid structure may increase a thermal conductivity, in particular by increasing a surface area contacted by the phase change material. Preferably, the second grid structure is a fine grid structure with small distances between individual grid rods in order to provide a particularly large surface area for the heat transfer.

The first grid structure may differ from the second grid structure. For example, the second grid structure may be finer than the first grid structure. Alternatively or additionally, respective grid rods of the first grid structure may have a different thickness than the respective grid rods of the second grid structure. A grid structure may be formed, for example, from a plurality of intersecting grid rods.

In one embodiment of the battery device, it is provided that the core structure is configured as double-walled with a further wall. The further wall may also be configured substantially in the form of a triple periodic minimum surface. In the case of a double-walled core structure, the two walls may be arranged substantially parallel to one another. For example, the basic shape of both walls may be the same. The two walls may be offset with respect to one another. One of the two walls may be smaller and be arranged, for example, between the other wall and the second interior space. An intermediate space may be formed between the two walls of the core structure. The double-walled core structure may be particularly robust. Further phase change material may be arranged in the further intermediate space. This phase change material may have a different melting point than the phase change material in the second interior space in order to further stabilize the operating temperature. For example, one of the phase change materials may melt at an upper limit of a desired operating temperature range and the other phase change material may melt at a desired lower limit of the desired operating temperature range. Alternatively, the intermediate space may be configured for a cooling fluid to flow through. As a result, active cooling can be carried out in a particularly variable manner, for example with different cooling fluids in the intermediate space and the first interior space. For example, a constant cooling fluid volume flow may flow through the first interior space and cooling fluid may only flow through the intermediate space as soon as the phase change material begins to melt.

In one embodiment of the battery device, it is provided that the intermediate space is configured for a cooling fluid to flow through and/or a phase change material is arranged in the intermediate space.

In one embodiment of the battery device, it is provided that the core structure further has a third grid structure which is arranged in the intermediate space. The third grid structure may fasten and support the two walls of the double-walled core structure to one another. The two walls of the core structure may be connected to one another via the third grid structure. As a result, the core structure is particularly resistant and can absorb high mechanical loads. Alternatively, however, the two walls may also be arranged next to one another in a self-supporting manner, for example. The third grid structure may improve a heat transfer between the two walls of the core structure and to a material in the intermediate space.

In one embodiment of the battery device, it is provided that the respective walls of the core structure are formed as a Schwarz-P-surface. The Schwarz-P-surface naturally forms a geometry that spans two separate spaces, thereby forming recesses for cylindrical batteries. A Schwarz-P surface can be approximated, for example, in a three-dimensional Cartesian coordinate system with the coordinates x, y and z by the equation cos(x)+cos(y)+cos(z)=0. By inserting further parameters, the geometry can be compressed or stretched to adapt it to batteries of different shapes. The formula cos(a*x)+cos(b*y)+cos(c*z)=0 can be used as an approximation. However, the Schwarz-P-surface can also be determined exactly by solving the Weierstrass-Enneper-formula.

In one embodiment of the battery device, it is provided that respective walls of the core structure are determined in a manner adapted to the battery cell shape. For example, respective walls of the core structure may have a hexagonal symmetry. As a result, a suitable shape with matching recesses can be provided for specific battery cells.

A further aspect relates to a method for determining a shape of a wall of a core structure of a battery device, in particular one of the walls of the core structure of the battery device according to the invention. The method may comprise a step of selecting a battery cell shape of respective battery cells of the battery device. The method may comprise a step of defining an arrangement of the battery cells in a desired packing, in particular in a plane. The method may comprise a step of identifying planes of symmetry in the defined arrangement of the battery cells. The method may comprise a step of reducing battery cell surfaces in the defined arrangement to a smallest symmetrical unit. The method may comprise a step of selecting contact surfaces of the battery cells with the wall. The method may comprise a step of defining contact lines on the selected contact surfaces. The method may comprise a step of defining the spatial position of the contact lines. The method may comprise a step of determining the shape of the wall as a substantially triple periodic minimum surface as a function of the defined spatial position of the contact lines and as a function of the identified planes of symmetry. As a result, battery-device-specific triple periodic minimum surfaces can be determined in a simple manner. The step of determining the shape of the wall as a substantially triple periodic minimum surface may comprise converting an attachment surface formed from the defined contact lines into a mesh of prestressed spring elements and mass points in order to determine a spring mass system. The step of determining the shape of the wall as a substantially triple periodic minimum surface may comprise a dynamic simulation of the spring mass system until an equilibrium position is reached. An excated finite element method solver such as, for example, ABAQUS/explicit is suitable for this purpose, for example. The step of determining the shape of the wall as a substantially triple periodic minimum surface may comprise converting the equilibrium position into a geometry surface in order to determine a minimum surface. The step of determining the shape of the wall as a substantially triple periodic minimum surface may comprise mirroring the geometry surface over all identified planes of symmetry in order to create a cell of the triple periodic minimum surface. The step of determining the shape of the wall as a substantially triple periodic minimum surface may comprise periodically placing the created cell against one another according to the arrangement of the battery cells in the desired packing in order to determine the shape of the wall of the core structure.

In one embodiment of the battery device, it is provided that the shape of the respective walls of the core structure, which in particular separates the two interior spaces from one another, is matched to a shape of the battery cell. As a result, the battery device may be particularly compact. For example, respective recesses in the second interior space may be adapted to the shape of the battery cells. In particular, a cross section of the recess may correspond to a cross section of the battery cell. For example, the shape of the wall of the core structure may be matched to a cylindrical shape or a prismatic shape of the battery cell or to a battery cell configured as a pouch cell.

In one embodiment of the battery device, it is provided that the battery device has a pump device which is configured to convey the cooling fluid through the first interior space. For example, the pump device may be connected to the first interior space via one or more through openings in at least one cover layer. The pump device may also be configured to convey cooling fluid through the intermediate space if the core structure is configured as double-walled. The pump device may have, for example, a pump. The battery device may also have the cooling fluid.

### BRIEF DESCRIPTION OF THE FIGURES

FIG. 1 illustrates in a schematic perspective view a first embodiment of a core structure of a battery device;

FIG. 2 illustrates in a schematic perspective view how a cooling fluid can flow around the first embodiment of the core structure of the battery device;

FIG. 3 illustrates in a schematic sectional view how the first embodiment of the core structure of the battery device accommodates respective battery cells and a phase change material;

FIG. 4 illustrates in a further schematic sectional view how the first embodiment of the core structure of the battery device accommodates respective battery cells and a phase change material;

FIG. 5 illustrates in a schematic perspective view how the first embodiment of the core structure can be manufactured in a deep-drawing method;

FIG. 6 illustrates in a schematic perspective view a second embodiment of a core structure of the battery device which has additional grid structures;

FIG. 7 illustrates in a schematic sectional view the grid structures of the second embodiment of the core structure of the battery device;

FIG. 8 illustrates in a schematic perspective view a third embodiment of a core structure of the battery device which is configured as double-walled;

FIG. 9 illustrates in a schematic sectional view an intermediate space formed by the double-walled core structure;

FIG. 10 illustrates schematically a method for determining a shape of a triple periodic minimum surface for the core structure; and

FIG. 11 illustrates in different views a shape of the core structure with hexagonal symmetry determined with the method according to FIG. 10.

### DETAILED DESCRIPTION OF EMBODIMENTS

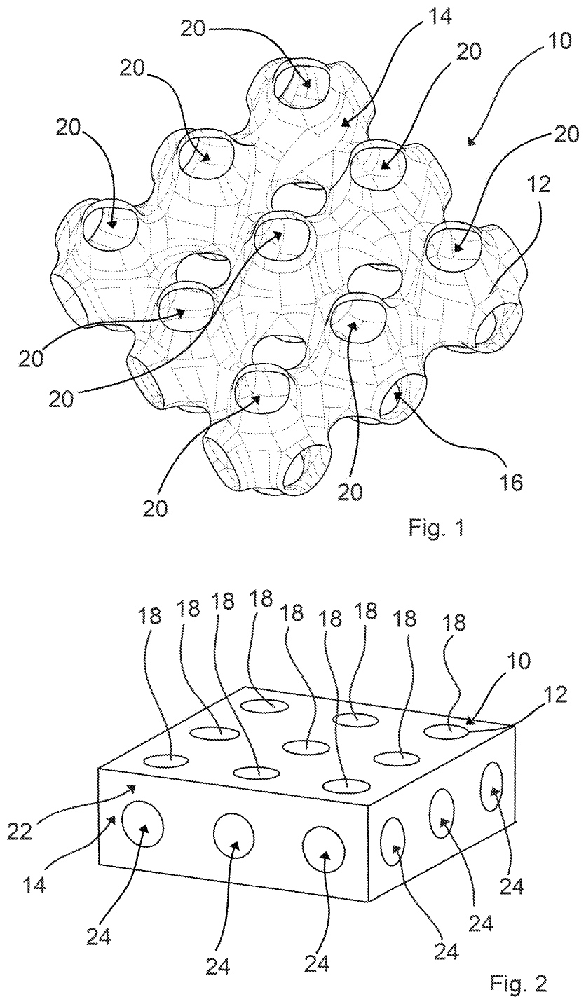

FIG. 1 illustrates in a schematic perspective view a first embodiment of a core structure 10 of a battery device. The core structure 10 has a wall 12 which is configured in the form of a triple periodic minimum surface. In the example shown, the wall 12 of the core structure 10 is configured as a Schwarz-P-surface.

The battery device has a housing (not shown) which is configured here, for example, in a rectangular manner and completely accommodates the core structure 10. The core structure 10 regionally abuts the housing on the outer side and is held by it. On the upper side and lower side, the housing respectively forms a cover layer which abuts the wall 12 and is joined to the wall 12 of the core structure 10. As a result, a resistant sandwich structure is formed with the core structure. A housing interior space is separated by the core structure 10 into a first interior space 14 and a second interior space 16, so that no fluid transmission between the two interior spaces 14, 16 is possible.

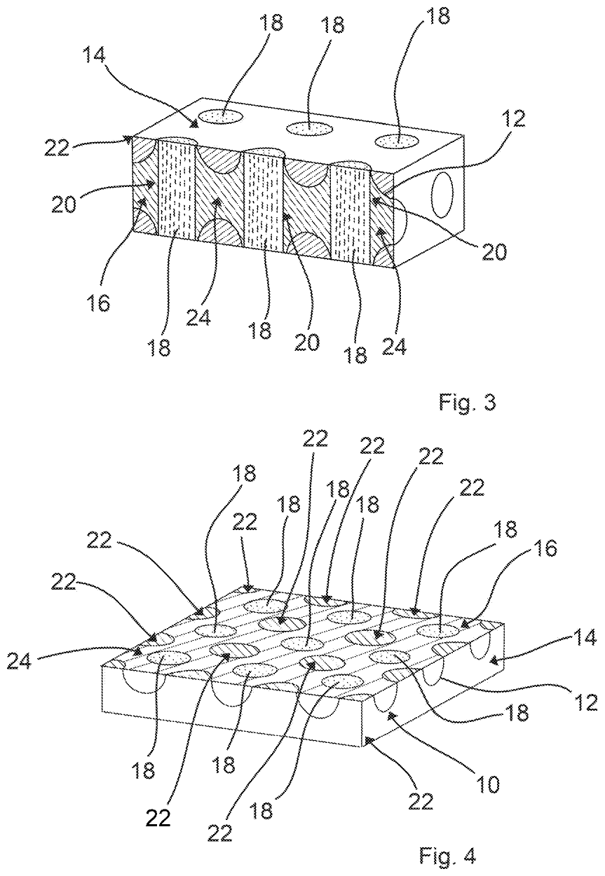

The battery device has a multiplicity of battery cells 18 which are arranged uniformly in a packing and which, in the example shown, are configured as cylindrical battery cells 18 and are shown in FIGS. 2 to 4. In FIGS. 2 to 4, it can be seen that the core structure 10 forms individual recesses 20 in the second interior space 16, which recesses correspond to a shape of the battery cells 18. An associated battery cell 18 is arranged in each recess 20. In the example shown, the battery device has only one level of battery cells 18. However, the battery device may also have a plurality of levels of battery cells 18 arranged one above the other and can thus be extended in the vertical direction. For this purpose, a plurality of core structures 10 can be stacked one above the other or the core structure 10 can be extended in the vertical direction, wherein additional recesses 20 are formed for the further battery cell levels.

The first interior space 14 is configured for a cooling fluid 22 to flow through. In FIGS. 2 to 4, it can be seen that the first interior space 14 is completely filled with cooling fluid 22. The cooling fluid 22 is, for example, a water-glycol mixture. The battery device has a pump device which is connected to the first interior space 14 via an inlet and an outlet in order to convey the cooling fluid 22 through the first interior space 14. A temperature of the battery device can thus be actively controlled, for example for cooling and heating. On the upper side and/or lower side, the battery cells 18 are not in contact with the cooling fluid 22. There, the battery cells 18 are electrically connected in order to be able to supply an electrical current to a load and to be charged.

For this purpose, the cover layers respectively have associated through openings which are aligned with the battery cells 18 and the recesses 20. The cover layers are formed, for example, from an electrically insulating material in a sandwich construction, wherein respective conducting paths are deposited or etched in on a side facing away from the first interior space 14.

The second interior space 16 fluidically connects the recesses 20 to one another. A phase change material 24, for example paraffin wax, is arranged in the second interior space 16 and surrounds the battery cells 18. The phase change material 24 forms a thermal buffer and increases a thermal inertia of the battery device considerably in the desired operating temperature range of the battery device. The core structure 10 is formed, for example, from a metallic material in order to enable a rapid heat transfer between the first interior space 14 and the second interior space 16 and thus the cooling fluid 22 and the phase change material 24.

In another embodiment, the phase change material 24 is arranged in the first interior space 14 and the cooling fluid 22 is arranged in the second interior space 16. In this case, the pump device is connected to the second interior space 16 via an inlet and an outlet in order to convey the cooling fluid 22 through.

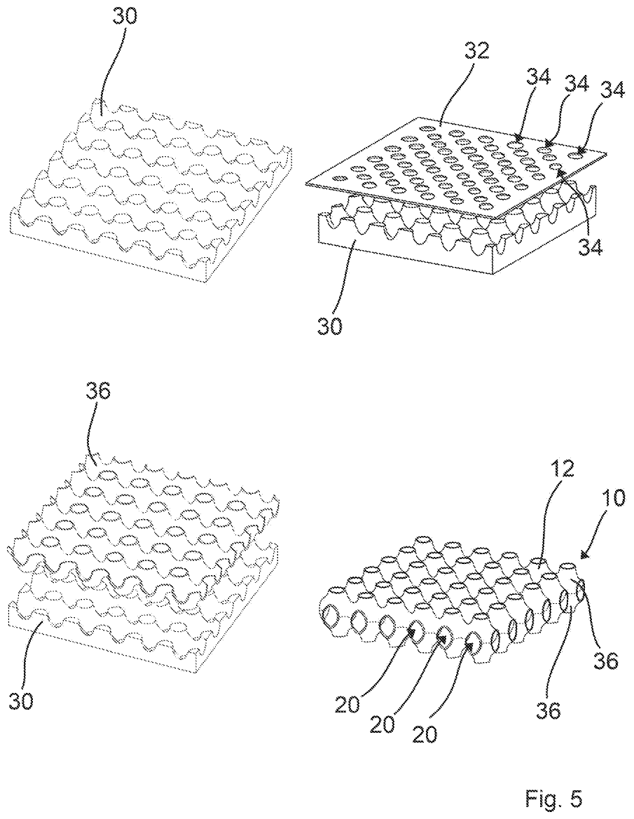

The core structure 10 may be manufactured, for example, with an additive method, as a result of which the complex geometry of the core structure 10 can be produced in a particularly simple manner. FIG. 5 illustrates in different schematic views a forming method for manufacturing the core structure 10. Shown is a deep-drawing tool 30 which forms a negative shape of a part of the wall 12. A sheet metal plate 32 which has through openings 34 corresponding to the recesses 20 is placed on the deep-drawing tool 30. By pressing with a further deep-drawing tool (not shown), a semi-finished product 36 is formed from the sheet metal plate 32, the shape of which semi-finished product corresponds to an upper or lower half of the core structure 10. Two such semi-finished products 36 are joined to one another, for example by adhesive bonding, soldering or welding, in order to form the wall 12 of the core structure 10 as shown in FIG. 5. As a result, a cost-effective mass production is possible.

A shape of the cover layer corresponds, for example, to the shape of the sheet metal plate 32 shown in FIG. 5, from which the semi-finished products 36 are deep-drawn.

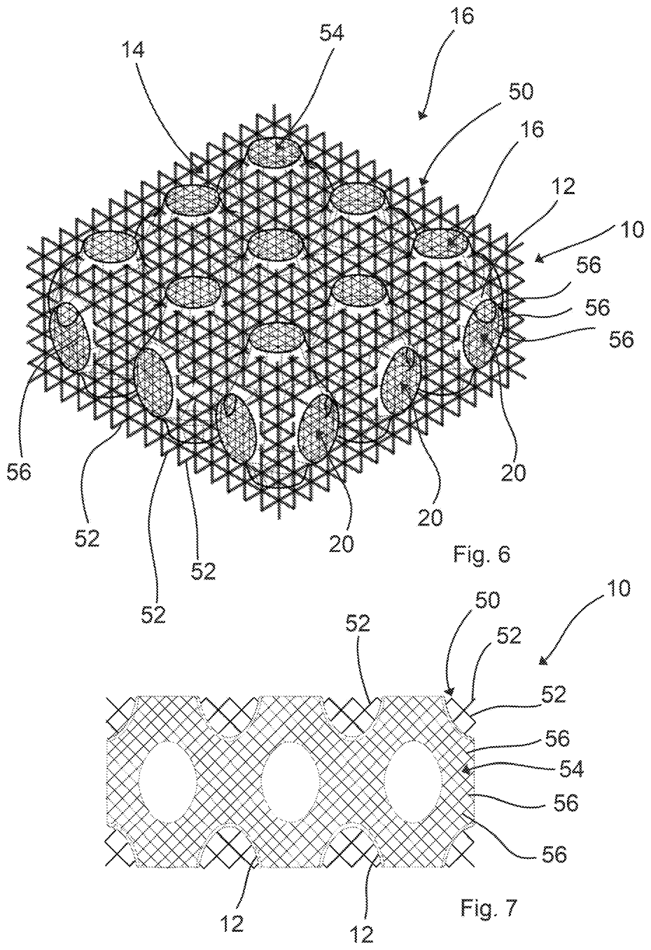

FIG. 6 illustrates in a schematic perspective view and FIG. 7 illustrates in a schematic sectional view a second embodiment of the core structure 10 of the battery device. Only differences with respect to the first embodiment are described, since the basic construction and the basic mode of operation are identical to the first embodiment.

The second embodiment of the core structure 10 has a first grid structure 50, which is arranged in the first interior space 14. The first grid structure 50 is formed from uniformly arranged metallic grid rods 52, which intersect and are connected to the wall 12. In addition, the grid rods may also be connected to the housing, in particular the cover layers, in order to structurally reinforce the housing. The first grid structure 50 improves a heat transfer between the wall 12 and the cooling fluid 22, since a contact surface area is increased.

The second embodiment of the core structure 10 has a second grid structure 54, which is arranged in the second interior space 16. The second grid structure 54 is formed from uniformly arranged metallic grid rods 56, which intersect and are connected to the wall 12. The second grid structure 54 can thus stiffen the wall 12. The second grid structure 54 improves a heat transfer between the wall 12 and the phase change material 24 and the battery cells 18, since a contact surface area is increased. The grid rods 56 of the second grid structure 54 may be contacted with the battery cells 18, in order to additionally support them during a change of the phase change material 24 into the liquid state. However, the grid rods 56 of the second grid structure 54 may also be spaced apart from the battery cells 18.

The first grid structure 50 has greater distances between the grid rods 52 thereof than the second grid structure 54 between the grid rods 56 thereof. The first grid structure 50 is coarser than the second grid structure 54. As a result of the coarse first grid structure 50, an undesirably high flow resistance for the cooling fluid 22 in the first interior space 14 can be avoided. As a result of the fine second grid structure 54, a particularly good heat transfer between the phase change material 24 and other regions can be achieved, as a result of which a particularly good thermal damping is made possible.

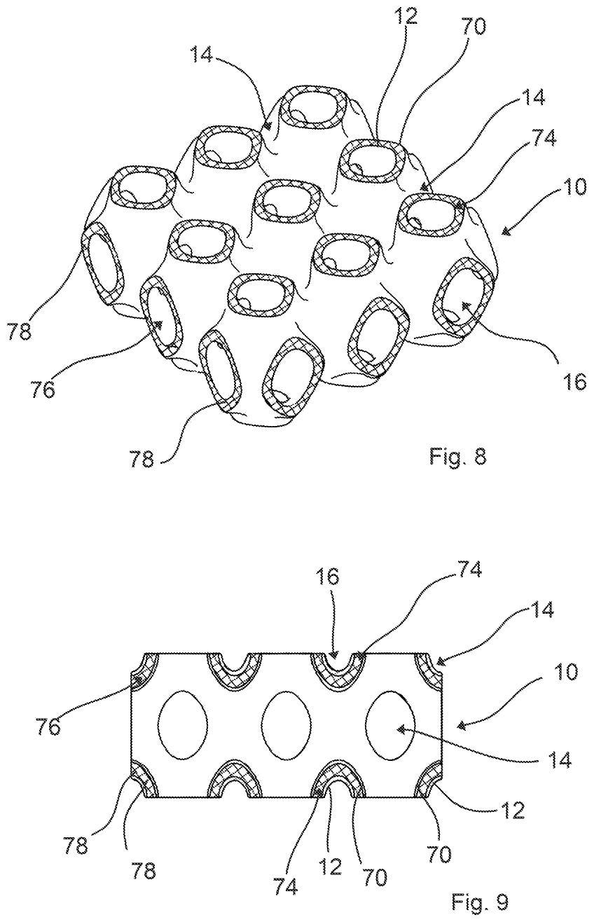

FIG. 8 illustrates in a schematic perspective view and FIG. 9 illustrates in a schematic sectional view a third embodiment of the core structure 10 of the battery device. Only differences with respect to the first embodiment are described, since the basic construction and the basic mode of operation are identical to the first embodiment.

The core structure 10 according to the third embodiment is configured as double-walled with a further wall 70. The further wall 70 is arranged parallel to the wall 12 and likewise has a shape of a triple periodic minimum surface, in the example shown as a Schwarz-P-surface. The core structure forms an intermediate space 74 between the two walls 12, 70. The two walls 12, 70 are respectively connected to the cover layers and thus do not have to be fastened to one another. In the example shown, however, the two walls 12, 70 are connected to one another by means of an optional third grid structure 76 which is arranged in the intermediate space 74 and which has respective grid rods 78. The third grid structure 76 improves a heat transfer between the two walls 12, 70 and to a material arranged in the intermediate space 74. In addition, third grid structure 76 can make the core structure 10 more robust with respect to mechanical loads.

The core structure 10 according to the third embodiment may be free of the first grid structure 50 and the second grid structure 54, as shown in FIG. 9. In another embodiment, however, in addition to the third grid structure 76, the first grid structure 50 and/or the second grid structure 54 may also be provided. The intermediate space 70 may be configured for a cooling fluid to flow through and for this purpose be fluidically connected to the pump device. Alternatively, a phase change material may be arranged in the intermediate space 70.

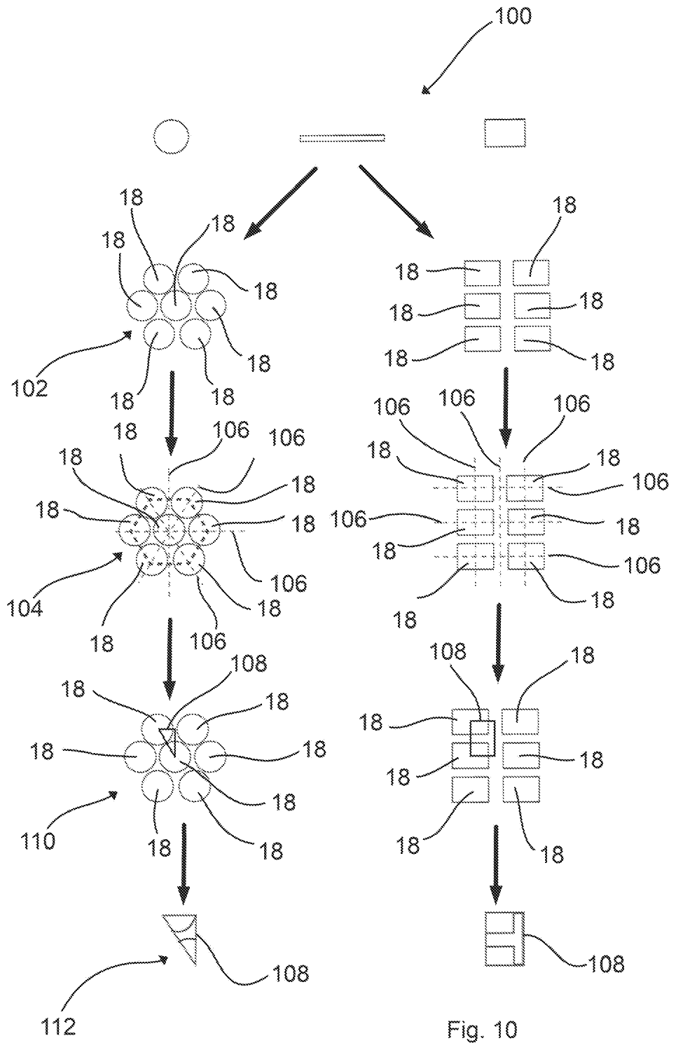

FIG. 10 illustrates schematically a method for determining a shape of a triple periodic minimum surface for the core structure 10. In step 100, a battery cell shape of respective battery cells 18 of the battery device is selected. Shown is a cross section of typical battery cell shapes, namely cylindrical battery cells, prismatic battery cells and pouch cells. In step 102, an arrangement of the battery cells 18 in a desired packing in a plane is defined. The cylindrical battery cells 18 are arranged uniformly, for example, in concentric circles around one another. The prismatic battery cells 18 are arranged uniformly, for example, in rows. In step 104, planes of symmetry 106 in the defined arrangement of the battery cells 18 are identified. In step 110, battery cell surfaces in the defined arrangement are reduced to a smallest symmetrical unit, which is illustrated by box 108. In step 112, contact surfaces of the battery cells 18 with the wall 12 of the core structure 10 are selected in the smallest symmetrical unit 108. Contact lines are defined on the selected contact surfaces. Subsequently, the spatial position of the contact lines is defined. As a function of the defined spatial position of the contact lines and as a function of the identified planes of symmetry, the shape of the wall 10 is determined as a substantially triple periodic minimum surface. The step of determining the shape of the wall as a substantially triple periodic minimum surface may comprise converting an attachment surface formed from the defined contact lines into a mesh of prestressed spring elements and mass points in order to determine a spring mass system. The step of determining the shape of the wall as a substantially triple periodic minimum surface may comprise a dynamic simulation of the spring mass system until an equilibrium position is reached. As a result, battery-device-specific triple periodic minimum surfaces can be determined in a simple manner. The step of determining the shape of the wall as a substantially triple periodic minimum surface may comprise converting the equilibrium position into a geometry surface in order to determine a minimum surface. The step of determining the shape of the wall as a substantially triple periodic minimum surface may comprise mirroring the geometry surface over all identified planes of symmetry in order to create a cell of the triple periodic minimum surface. The step of determining the shape of the wall as a substantially triple periodic minimum surface may comprise periodically placing the created cell against one another according to the arrangement of the battery cells in the desired packing in order to determine the shape of the wall of the core structure.

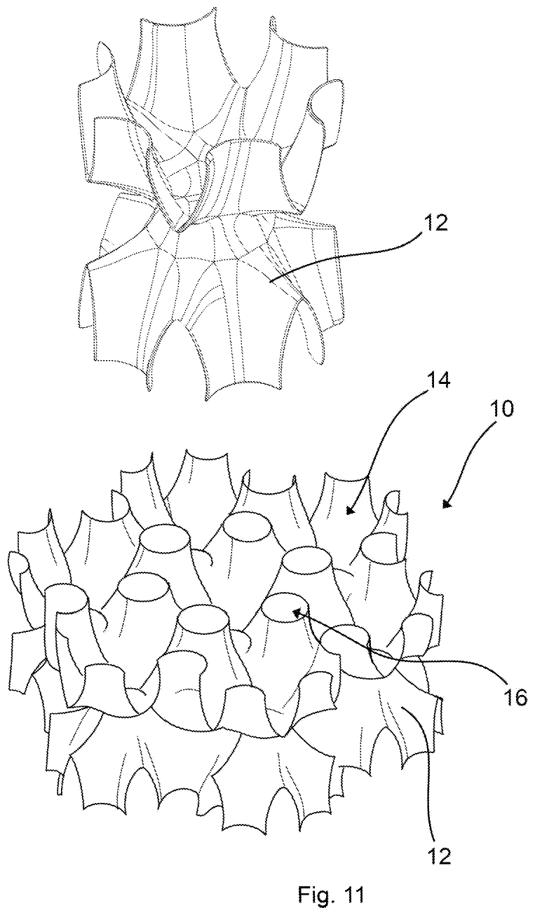

FIG. 11 shows in a perspective view a result of this method illustrated in FIG. 10. The core structure 10 in this case has a wall 12 with a hexagonal symmetry. In FIG. 11, an individual cell of the wall 12, which was determined according to the method described above, is also shown at the top. This cell is placed against one another periodically in order to produce the triple periodic minimum surface shape of the wall 12 from the cell.

### REFERENCE SIGNS

10 Core structure

### 12 Wall

14 First interior space
16 Second interior space
18 Battery cells

### 20 Recesses

22 Cooling fluid
24 Phase change material
30 Deep-drawing tool
32 Sheet metal plate
34 Through openings
36 Semi-finished product
50 First grid structure
52 Grid rods of the first grid structure
54 Second grid structure
56 Grid rods of the second grid structure
70 Further wall
74 Intermediate space
76 Third grid structure
78 Grid rods of the third grid structure
100 Step/selection of a battery cell shape
102 Step/definition of an arrangement of the battery cells
104 Step/identification of planes of symmetry
106 plane of symmetry
108 Box/smallest symmetrical unit
110 Step/reduction of battery cell surfaces
112 Step/selection of contact surfaces

1-10. (canceled)

11. A battery device, comprising:
a housing
a core structure arranged in the housing and separating a first interior space from a second interior spaced defined in the housing; the first interior space configured for a cooling fluid to flow through;
a phase change material arranged in the second interior space; and
at least one battery cell arranged in the first interior space or the second interior space;
wherein the core structure has a wall which is configured substantially in the form of a triple periodic minimum surface.

12. The battery device according to claim 11, wherein the first interior space and/or the second interior space is delimited on one side by a cover layer and on an opposite side by a further cover layer.

13. The battery device according to claim 12, wherein the cover layers regionally abut the core structure and/or form a sandwich structure with the core structure.

14. The battery device according to claim 12, wherein:
at least one of the cover layers has at least one through opening for access to a battery contact of the battery cell and/or for the cooling fluid to flow through;
and/or
at least one of the cover layers has a conducting path which is contacted with the battery cell.

15. The battery device according to claim 12, wherein at least one of the cover layers has a conducting path which is contacted with the battery cell and the conducting path is arranged on an outer side of the cover layer.

16. The battery device according to claim 11, wherein:
the core structure further has a grid structure arranged in the first interior space;
and/or
the core structure further has a grid structure arranged in the second interior space.

17. The battery device according to claim 11, wherein the core structure further has a first grid structure arranged in the first interior space and a second grid structure arranged in the second interior space, wherein the first grid structure differs from the second grid structure.

18. The battery device according to claim 11, wherein the core structure is configured as double-walled with a further wall, wherein the further wall is also configured substantially in the form of a triple periodic minimum surface, and an intermediate space is formed between the wall and the further wall of the core structure.

19. The battery device according to claim 18, wherein the intermediate space is configured for a further cooling fluid to flow through and/or a further phase change material is arranged in the intermediate space.

20. The battery device according to claim 18, wherein the core structure further has a grid structure arranged in the intermediate space and the wall and further wall of the core structure are connected to one another via the grid structure.

21. The battery device according to claim 11, wherein the wall of the core structure is configured as a Schwarz-P-surface or has a hexagonal symmetry.

22. The battery device according to claim 11, wherein a shape of the wall of the core structure is matched to a shape of the battery cell.

23. The battery device according to claim 22, wherein the shape of the battery cell is a cylindrical shape or a prismatic shape, or the battery cell is configured as a pouch cell.

24. The battery device according to claim 11, further comprising a pump device which is configured to convey the cooling fluid through the first interior space.

25. The battery device according to claim 11, wherein the battery device is for a motor vehicle or a battery store in a building.

26. A method of manufacturing a battery device according to claim 11, comprising:
manufacturing the core structure by an additive method, a casting method, a machining method and/or a forming method.

27. The method according to claim 26, further comprising forming the core structure from two semi-finished products which are joined to one another.
